(19) United States
(12) Patent Application Publication
(10) Pub. No.: US 2019/0203513 A1
(43) Pub. Date: Jul. 4, 2019

(54) TRACK GUARD FOR OVERHEAD DOORS

(71) Applicant: ASSA ABLOY Entrance Systems AB, Landskrona (SE)

(72) Inventors: Joshua James Brown, Waukesha, WI (US); David Griffis, Sussex, WI (US); Maxwell MacLeay, Sussex, WI (US)

(21) Appl. No.: 16/240,426

(22) Filed: Jan. 4, 2019

Related U.S. Application Data
(60) Provisional application No. 62/613,693, filed on Jan. 4, 2018.

(51) Int. Cl. E05D 15/22; E05D 15/16; E01B 5/18

(52) U.S. Cl. CPC E05D 15/22; E05D 15/165; E05D 2015/225; E05Y 2800/40; E05Y 2900/106; E01B 5/18

(57) ABSTRACT

Track guards for use with overhead doors at loading docks, residential locations, and other facilities are described herein. In some embodiments, the track guards described herein can be two-part assemblies having a first part (e.g., a base member) that mounts directly to a door jamb, and a second part (e.g., an outer member or cap) that can be adjustably positioned relative to a door guide rail and then fixedly attached to the base member. In some embodiments, the outer member can include recesses or pockets, elongate edge features, and/or other shapes that are configured to clip onto or otherwise cover a portion of the guide rail to provide support and/or prevent, or at least reduce the likelihood of, damage from operational loads and/or impacts to the guide rail. Additionally, in some embodiments the track guards described herein can include various types of attachment features so that lights, reflective elements, motion sensors, fans, and/or other devices can be quickly and easily mounted to the track guard at various positions near the door opening to facilitate operations at the loading dock.

### CROSS-REFERENCE TO RELATED APPLICATION(S) INCORPORATED BY REFERENCE

The present application claims priority to and the benefit of U.S. Provisional Patent Application No. 62/613,693, filed Jan. 4, 2018, and titled TRACK GUARD FOR OVERHEAD SECTIONAL DOOR, which is incorporated herein by reference in its entirety.

U.S. Provisional Patent Application No. 62/670,558, filed May 11, 2018, and titled LIGHTING SYSTEMS FOR USE IN RESIDENTIAL GARAGES AND OTHER LOCATIONS, is incorporated herein by reference in its entirety.

### TECHNICAL FIELD

The present disclosure is generally related to overhead doors, and more specifically, to apparatuses, systems and methods for protecting guide tracks for such doors at loading docks, residential locations, and other locations.

### BACKGROUND

Overhead doors have been used at loading docks and in other warehouse, factory, and residential settings for many years. The two main functions of loading dock doors are to provide a barrier to the outside environment when the door is closed, and to provide a portal for direct access to a shipping trailer parked at the loading dock when the door is open. Conventional overhead doors are of the sectional type, and typically include four or more rectangular panel sections hinged together along the upper and lower edges. Each of the panel sections typically carries at least two guide members (e.g., plungers or roller devices) that extend outwardly from the left and right sides of the panel section. The guide members are movably received in door tracks that are attached to the door jamb and extend vertically along the respective sides of the door. The door tracks guide the door as it moves upwardly into the overhead or “open” position and back down into the “closed” position.

Conventional overhead doors are susceptible to damage when used at warehouses, factories, and other commercial, industrial, and/or residential settings. Occasionally, for example, a forklift operator may inadvertently drive the forklift into the door track and bend it out of alignment. Such damage to door tracks can significantly hinder operations at loading docks and require time-consuming and costly repairs. Accordingly, it would be advantageous to be able to protect door tracks in loading dock environments. Additionally, it would also be advantageous to be able to easily mount lights, fans and/or other loading dock equipment near the door tracks to facilitate efficient loading dock operations.

### BRIEF DESCRIPTION OF THE DRAWINGS

FIG. 1 is an interior isometric view of an overhead door assembly having a pair of track guards configured in accordance with an embodiment of the present technology.

FIG. 2 is an enlarged, cross-sectional isometric view of a portion of the door track and track guard of FIG. 1 configured in accordance with an embodiment of the present technology.

FIG. 3 is an isometric view of a portion of the door track of FIGS. 1 and 2 with the track guard removed for purposes of illustration.

FIGS. 4A and 4B are isometric views of the track guard of FIGS. 1 and 2 with the door track removed for purposes of illustration.

FIG. 5 is a cross-sectional, perspective end view of the track guard/door track combination taken substantially along line 5-5 of FIG. 1.

FIG. 6 is an isometric view of a track guard configured in accordance with another embodiment of the present technology.

FIGS. 7A-7C are a series of cross-sectional end views of track guards configured in accordance with various embodiments of the present technology.

FIGS. 8A and 8B are isometric views of a one-piece guard track configured in accordance with another embodiment of the present technology.

FIG. 9A is an isometric view of a track guard configured in accordance with a further embodiment of the present technology and having a lighting element attached thereto, FIG. 9B is an isometric view of the track guard of FIG. 9A having a reflective element attached thereto, and FIG. 9C is a cross-sectional end view of the track guard of FIG. 9A.

FIGS. 10A-10G are a series of views illustrating a new design of a track guard for use with an overhead door track.

### DETAILED DESCRIPTION

The following disclosure describes various embodiments of apparatuses (e.g., track guards) that can be mounted to, or proximate to, overhead door guide tracks at loading docks and other commercial and residential locations to protect the guide tracks from damage. As described in greater detail below, some track guards configured in accordance with the present technology can be clipped onto or otherwise securely attached to, or near, a door guide track, and can be adjustable to accommodate virtually any type of guide track in virtually any type of orientation or position. Additionally, some embodiments of track guards configured in accordance with the present technology can also include various attachment features so that the track guard acts as a “hub” for attachment of a wide array of accessories to the track guard. Such accessories can include, for example, lights, fans, and/or other devices that can facilitate operations at the loading dock, such as the loading and/or unloading of cargo from trailers.

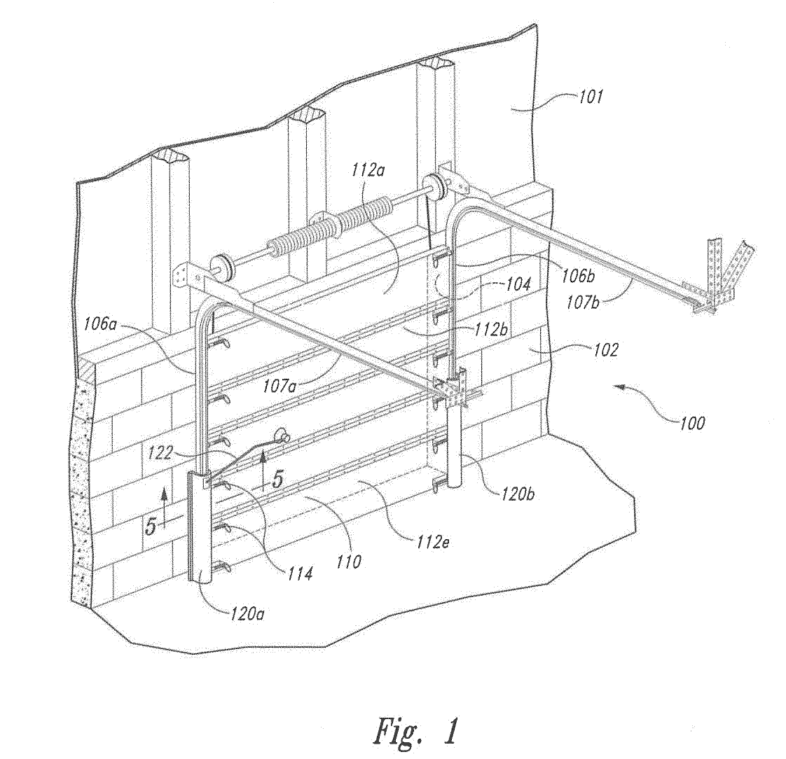

Certain details are set forth in the following description and in FIGS. 1-10G to provide a thorough understanding of various embodiments of the present technology. In other instances, well-known structures, materials, operations and/or systems often associated with loading docks, overhead sectional doors, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below. In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an interior isometric view of an overhead door assembly 100 having a pair of track guards 120 (identified individually as a first, or left-side, track guard 120a and a second, or right-side, track guard 120b) configured in accordance with an embodiment of the present technology. In the illustrated embodiment, the overhead door assembly 100 is used to cover an opening 104 in a wall 102 at a loading dock of a building 101 (e.g., a warehouse, factory, or other type of commercial/industrial building). The door assembly 100 includes a sectional door 110 that is moveably supported in a left-side door track 106a and a right-side door track 106b in a conventional manner. The sectional door 110 includes a plurality of rectangular door panels 112 (identified individually as door panels 112a-e) which are pivotally attached to each other along upper and lower hinge lines. Each of the door panels can include at least one guide member 114 on each of the left and right sides that is moveably received in the corresponding door track 106 so that the door 110 follows the door tracks 106 as the door is moved upwardly and overhead to clear the opening 104.

When the door 110 is fully raised, forklifts and personnel can cross through the opening 104 to load and/or unload cargo from a shipping trailer parked directly outside the opening. In the illustrated embodiment, the track guards 120 are mounted to, or proximate to, the corresponding door tracks 106 at the base of the door tracks 106 near floor level. As described in greater detail below, the track guards 120 can protect the door tracks 106 from impact damage from, for example, a forklift or cargo that inadvertently strikes the door tracks 106 during loading and/or unloading process. Additionally, the track guards 120 can include various attachment features (e.g., sockets, channels, fastener provisions, etc.) to enable devices, such as a light 122, to be easily attached to the track guard 120a proximate the door opening 104 to facilitate operations at the loading dock. In other embodiments, the track guards 120 can be mounted to, or proximate to, the vertical portions of the door tracks 106 at different elevations relative to the floor. Additionally, it is contemplated that embodiments of the track guards described herein can also be mounted to horizontal portions 107a, b of the door tracks 106. In addition to protecting the horizontal portions 107a, b of the door tracks 106, track guards in this upper position can be used to, for example, support lighting, parking sensors, etc. (e.g., lighting or parking sensors in residential settings). Although the foregoing discussion is related to overhead sectional doors at loading docks, it will be understood that embodiments of track guards described herein can also be used in residential settings, such as with overhead sectional doors in residential garages, and with other types of overhead doors, such as roll-up doors, etc.

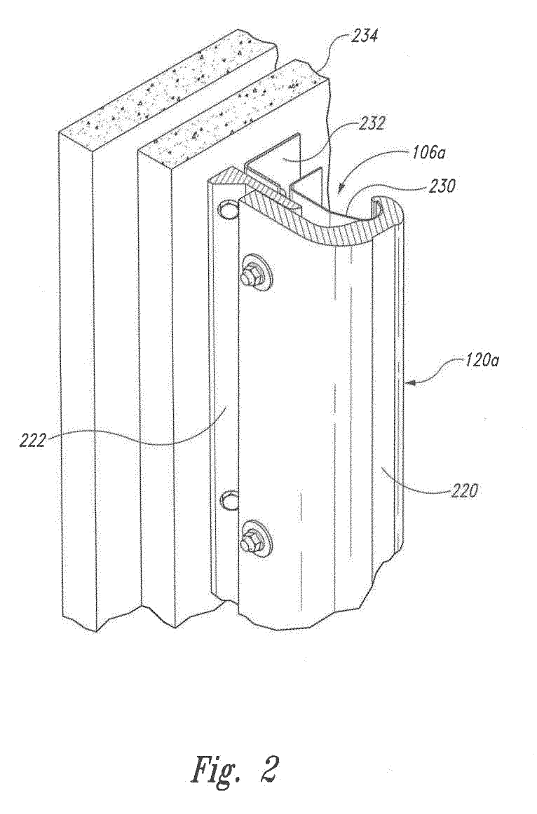

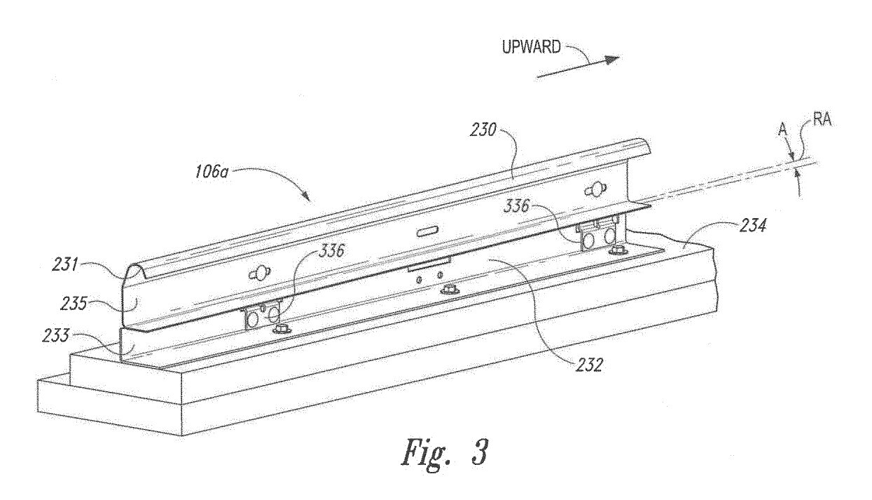

FIG. 2 is a cross-sectional isometric view of the left-side track guard 120a operably installed on the left-side door track 106a in accordance with an embodiment of the present technology. Although the discussion that follows describes the left-side track guard 120a and the corresponding portion of the left-side door track 106a, it will be understood that the door components on the right side of the door assembly 110 are essentially mirror images of the components on the left side, and as a result the forgoing description of the left-side door track 106a and associated track guard 120a applies equally to the corresponding components on the right side of the door assembly 110. Additionally, for ease of reference the following discussion will simply refer to the left-side door track 106a as the “door track 106a,” and the left-side track guard 120a as the “track guard 120a.” As shown in FIG. 2, the door track 106a includes a guide rail 230 that is fixedly attached to a bracket 232 which is in turn fixedly attached to a door jamb 234. The track guard 120a includes an outer member 220 and a base member 222, which is in turn fixedly attached to the door jamb 234. In some embodiments, the outer member 220 is an elongate, straight member of constant cross-section that is configured to extend longitudinally over a length of the door track 106a. The length of the outer member 220 can be selected based on the particular use, and can vary from, for example, 1 inch to 8 feet, 6 inches to 6 feet, 1 foot to 4 feet, etc. The foregoing structures are described in more detail below with reference to FIGS. 3-5.

FIG. 3 is an isometric view of a portion of the door track 106a from FIG. 2. In the illustrated embodiment, the guide rail 230 has a curved (e.g., a rounded) guide portion 231 configured to receive and retain rollers or similar devices on the door guide members 114 (FIG. 1) in a conventional manner. The guide rail 230 further includes a sidewall portion 235 that is fixedly attached to an upstanding leg portion 233 of the mounting bracket 232 by a plurality of brackets 336 in a conventional manner. This method of attachment enables the guide rail 230 to be positioned at a slight angle relative to the door jamb 234. More specifically, in the illustrated embodiment a longitudinal axis RA of the guide rail 230 is oriented at an angle A relative to the door jamb 234 so that the guide rail 230 is inclined slightly away from the door jamb 234 as the guide rail 230 extends upwardly relative to the door opening 104 (FIG. 1). The angle A can range from, for example, 0 degrees to about 5 degrees. As those of ordinary skill in the art will understand, in some embodiments the guide rail 230 and the mounting bracket 232 can be formed from a suitable sheet metal, such as mild steel plate or sheet, in a conventional manner.

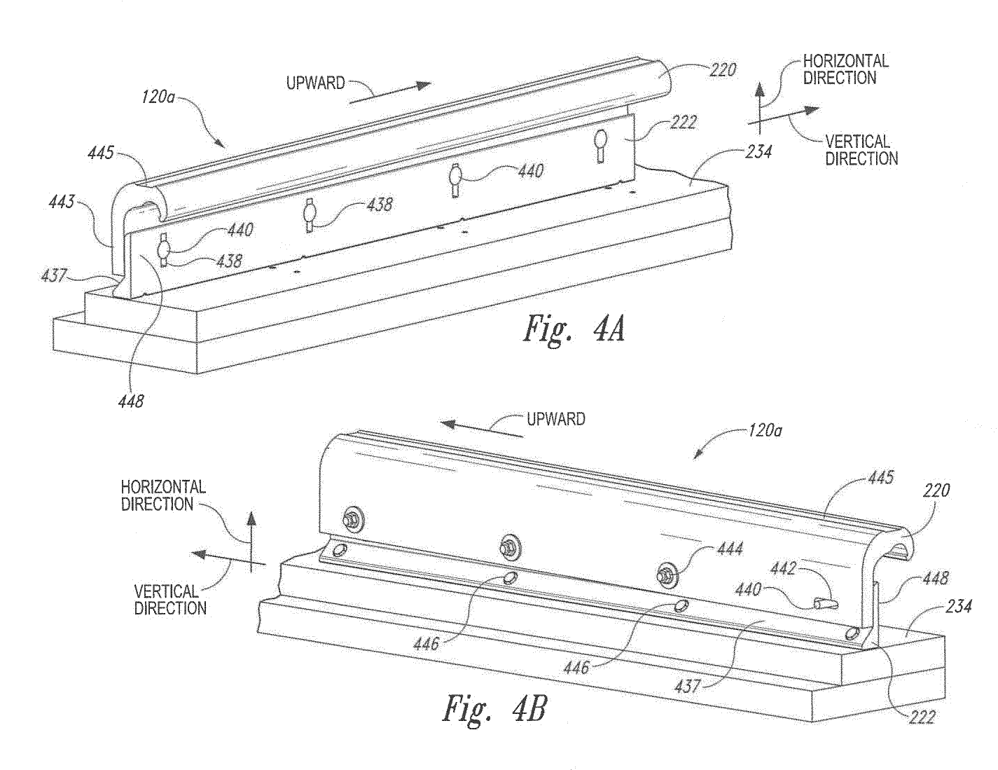

FIGS. 4A and 4B are right and left isometric views, respectively, of the track guard 120 configured in accordance with an embodiment of the present technology. In FIGS. 4A and 4B, the door track 106 (FIG. 3) has been omitted for purposes of illustration. Referring to FIGS. 4A and 4B together, as noted above the track guard 120a includes an outer member 220 attached to a base member 222. In the illustrated embodiment, the base member 222 includes a flange portion 448 extending from a base portion 437. The base portion 437 includes an angled surface that enables fasteners 446 (e.g., screws) to be installed therethrough at an angle to secure the base member 222 to the door jamb 234. The upstanding flange portion 448 includes a series of fastener holes 438 for attachment to the outer member 220. In the illustrated embodiment, the fastener holes 438 are elongated in the horizontal direction (i.e., generally perpendicular to the door jamb 234).

The outer member 220 includes a flange portion 443 extending from a cap portion 445. In the illustrated embodiment, the flange portion 443 includes a series of fastener holes 442 which are elongated in the vertical direction (i.e., the direction generally parallel to the door jamb 234). The elongated holes 442 can be aligned with the elongated holes 438 so that a plurality of fasteners 440 (e.g., bolts, screws, etc.) can be inserted therethrough and threadably engaged with corresponding nuts 444 to fixedly attach the outer member 220 to the base member 222. In one aspect of this embodiment, it should be noted that the elongated holes 438 in the base member 222, and the elongated holes 442 in the outer member 220, enable the position of the outer member 220 to be adjusted both in the horizontal and vertical directions relative to the door jamb 234. This enables the outer member 220 of the guard track 120a to be clipped or otherwise installed onto, or around, the guide rail 230 (FIG. 3) and accommodate virtually any operating position or orientation of the guide rail 230 relative to the doorjamb 234. In some embodiments, the base member 222 and the outer member 220 can be formed from ultra-high molecular weight (UHMW) polyethylene that is extruded or otherwise formed using known methods. In other embodiments, the track guard 120a and/or various portions thereof can be manufactured from other suitable materials including, for example, nylon, plastics, composite materials, metallic materials, etc.

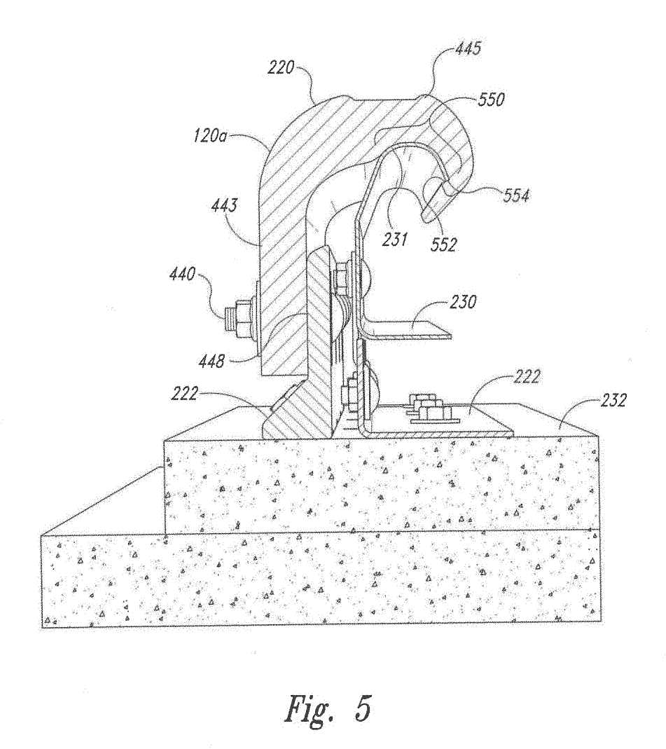

FIG. 5 is a cross-sectional perspective end view of the track guard 120a taken substantially along line 5-5 in FIG. 1. As this view illustrates, the cap portion 445 of the outer member 220 can have an “encompassing profile” or shape that can clip or otherwise be secured onto the door guide rail 230. For example, in the illustrated embodiment the cap portion 445 includes a recessed pocket portion 550 that has a complementary curved shape configured to receive the guide portion 231 of the guide rail 230. Additionally, in some embodiments the cap portion 445 can include a longitudinal lip or ridge 552 adjacent to the pocket portion 550 that is configured to abut a longitudinal edge 554 of the guide potion 231 and retain the guide rail 230 in position. It will be appreciated that, in some embodiments, the resiliency of the guide rail 230 and/or the outer member 220 enables the outer member 220 to be “clipped” or “snapped” into place on the guide portion 231, so that all or a portion of the outwardly facing surface of the guide portion 231 contacts the adjacent surface of the recessed pocket portion 550 as shown in FIG. 5. In other embodiments, the outer member 220 and/or the guide rail 230 can include additional or other physical features that facilitate engagement of the two parts in an advantageous manner similar to that illustrated in FIG. 5. In still further embodiments, however, the cap portion 445 of the outer member 220 can be slightly offset and/or spaced from the guide portion 231 of the guide rail 231. Moreover, as discussed above it will be appreciated that the horizontal orientation of the elongated holes 438 in the base member 222 (FIG. 4A) enable the outer member 220 to be moved into an optimum, or at least favorable, position relative to the guide rail 230 before the fasteners 440 are tightened.

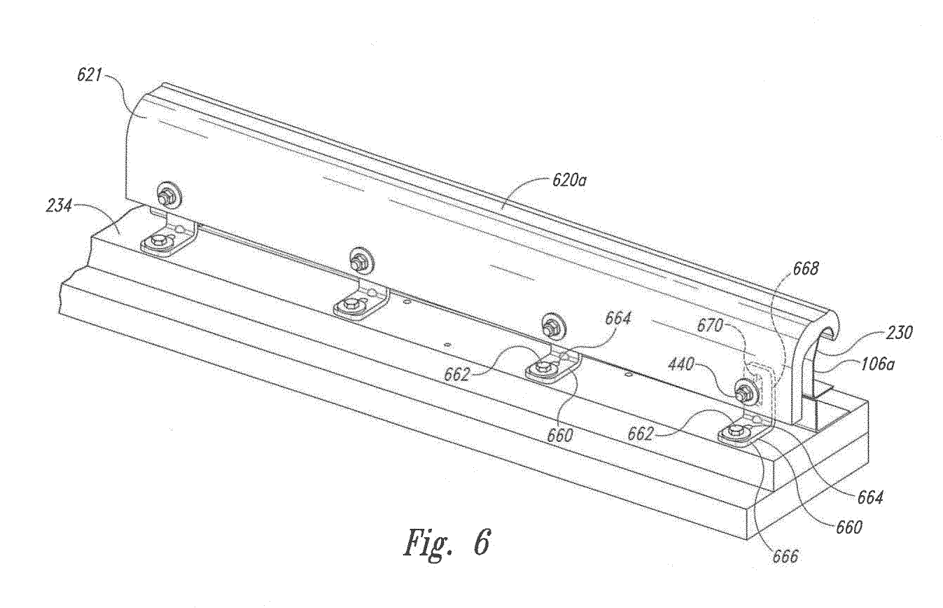

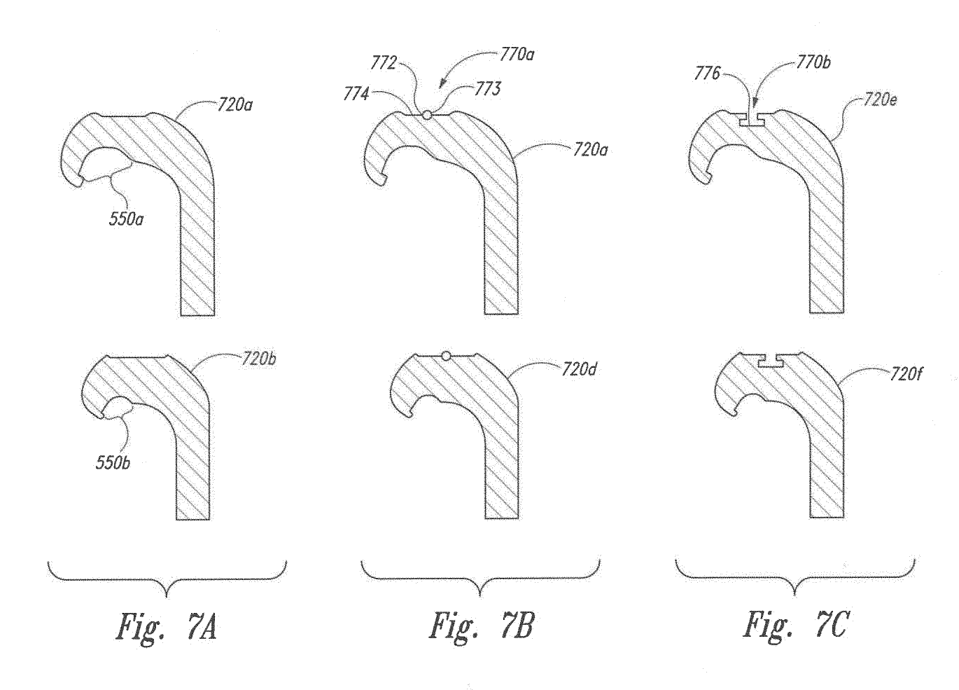

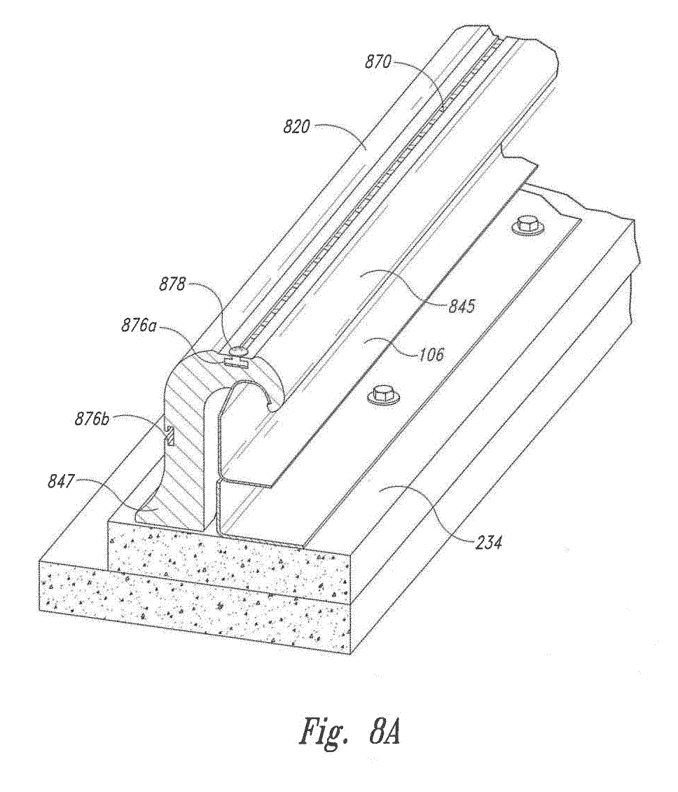

Although the outer member 220 is fixedly attached to the door jamb 234 by the base member 222 in the illustrated embodiment, in other embodiments the outer member 220 can be fixedly attached to the door jamb 234 with other structures in accordance with the present disclosure. For example, FIG. 6 is an isometric view of a track guard 620a that is operably mounted on, or at least near, the door track 106a in accordance with another embodiment of the present technology. In the illustrated embodiment, the track guard 620a includes an outer member 621 that is at least generally similar in structure and function to the outer member 220 described in detail above. However, in this embodiment the outer member 621 is positioned over the guide rail 230 and mounted to the door jamb 234 by means of a plurality of individual brackets 660. The brackets 660 are generally “L” brackets having a base portion 666 and an upstanding leg portion 668. The base portion 666 can include a laterally elongated hole 664 that enables the lateral position (e.g., the left and right position) of the outer member 220 to be adjusted relative to the guide rail 230 before the bracket 660 is fixedly attached to the door jamb 234 by means of a fastener 662 (e.g., a screw). Additionally, the upstanding leg 668 of each bracket 660 can include a horizontally elongated hole 670 that enables the position of the outer member 220 to be adjusted relative to the door jamb 234 to accommodate the position (e.g., an angled orientation) of the guide rail 230. This adjustment capability enables the outer member 220 to be clipped or otherwise properly positioned in place over the guide rail 230 as described above before the outer member 220 is fixedly attached to the brackets 660 by means of fasteners 440. As the forgoing illustrates, the present disclosure contemplates that the outer member 220 can be properly positioned on and/or directly over the guide rail 230 and attached to the door jamb 234 by various different attachments means.

The track guard 120a, and more particularly the outer member 220, can have a wide variety of different cross-sectional shapes for accommodating a variety of different door tracks having different shapes and sizes. Additionally, the outer member 220 can include a wide variety of different attachment features for quickly and easily attaching various accessories to the track guard 120a. For example, FIG. 7A-7C are cross-sectional end views of various types of track guard outer members 720a-f configured in accordance with the present technology. Referring first to FIG. 7A, the outer member 720a can be at least generally similar in structure and function to the outer member 220 described in detail above, and can accordingly include a pocket portion 550a configured to receive a standard 3 inch profile overhead door guide rail. The outer member 720b is similar to the outer member 720a, but is configured to accommodate a 2 inch profile standard guide rail and, accordingly, has a smaller pocket portion 550b configured to accommodate the smaller guide portion of the 2 inch standard guide rail. In some embodiments, the 2 inch profile may be advantageous for accommodating door tracks for overhead doors in residential applications.

Turning next to FIG. 7B, the outer members 720c and 720d are at least generally similar in structure and function to the outer members 720a and 720b, respectively, except that the outer members 720c and 720d include an attachment feature 770a for conveniently attaching accessories and/or other useful devices to the outer member 720c, d. For example, in the illustrated embodiment the attachment feature 770a can include an longitudinal channel or groove 772 adjacent to a generally flat mating surface 774. The groove 772 can have a partial circular cross-section configured to receive and/or retain a fiber optic light cable 773 having a similar circular cross-sectional shape. The fiber optic light can be used to illuminate the door opening and/or as a signaling device to alert personnel to the operational status of the dock. The flat surface 774 can be configured to receive, for example, a reflective foil or tape to enhance or otherwise function in combination with the fiber optic light 773. In other embodiments, the outer members 720c, d can include a plurality of pre-threaded holes configured to receive, for example, fasteners (e.g., screws; not shown) for attaching a dock light, a motion sensor, a fan, or other device to the outer member 720c, d.

FIG. 7C illustrates two outer members 720e and 720f which are configured to accommodate 3 inch and 2 inch standard guide rail profiles, respectively. Additionally, in the illustrated embodiment, the outer members 720e, f also include an attachment feature 770b for releasably attaching lights, sensors, speakers, control panels, etc. to the outer member 720. In the illustrated embodiment, the attachment feature 770b can include, for example, a groove or channel 776 having an inverted “T” cross-sectional shape. The channel 776 can be configured to receive, for example, a T-shaped protrusion or flange on the base of a light (e.g., the light 122 of FIG. 1) that enables the light to be clipped into the channel 776 to secure the light to the outer member 720 at a desired elevation and position relative to the dock opening. As the foregoing illustrates, the contour of the outer members 220 and 720 described above can be configured to accommodate virtually any size or shape of door guide rail, and can also be configured to include a wide variety of different attachment features so that accessories and other devices can be readily attached to the outer member to facilitate operations at the loading dock.

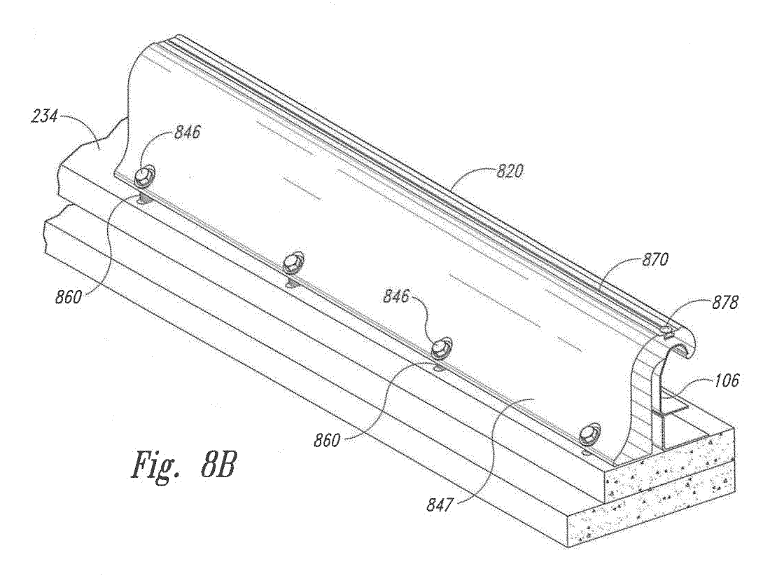

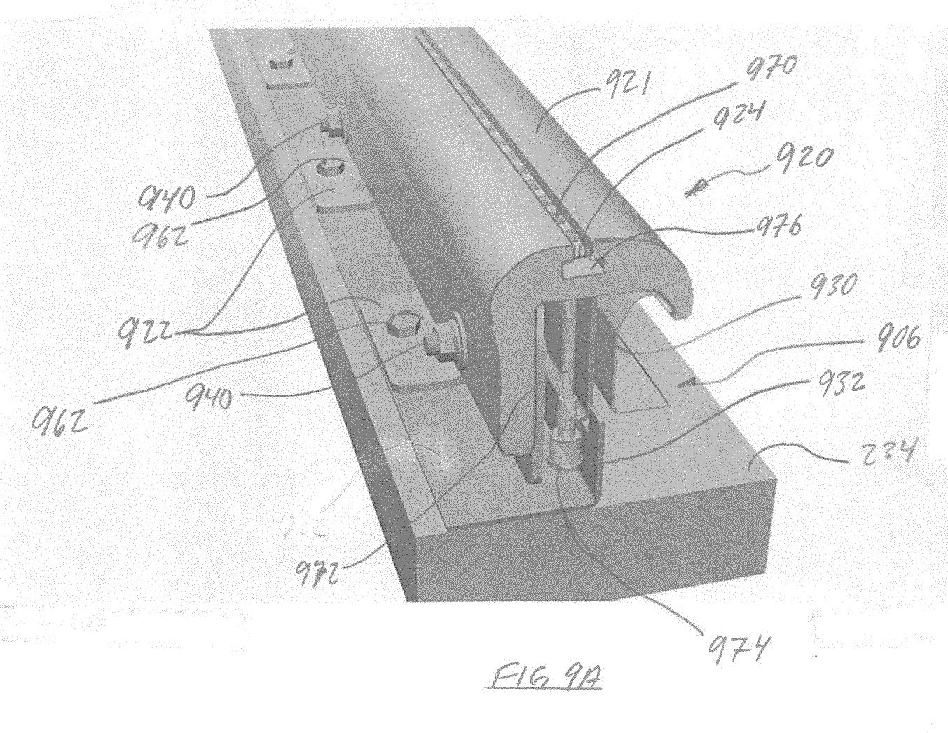

FIGS. 8A and 8B are isometric views of a track guard 820 configured in accordance with another embodiment of the present technology. In the illustrated embodiment, the track guard 820 is at least generally similar in structure and function to the track guards 120 described in detail above. In the illustrated embodiment, however, the track guard 820 is a one-piece track guard having a cap portion 845 and a base portion 847. Referring to FIGS. 8A and 8B together, in the illustrated embodiment the base portion 847 is attached to the door jamb 234 by a series of fasteners 846 (e.g., screws). In the illustrated embodiment, one or more spacers 860 (e.g., washers) can be positioned under the individual fasteners 846 to adjust the position (e.g., the angular position) of the track guard 820 relative to the door jamb 234 as needed to accommodate the particular orientation of the door track 106.

In a further aspect of this embodiment, the track guard 820 can include a longitudinal groove or channel 876a having an inverted “T” cross-sectional shape (similar to, e.g., the channel 776 described above with reference to FIG. 7C). In the illustrated embodiment, the channel 876a is configured to receive a lighting element, for example, an elongate light-emitting diode (LED) light strip 870 that can be secured in position with one or more fasteners 878. In some embodiments, the LED light strip 870 can function as a signal light that is able to illuminate in a number of different colors. For example, in one embodiment the LED light strip 870 can display a green light indicating that it is safe to use the dock door. Additionally, the LED light strip 870 can also be configured to display an amber colored light to indicate that personnel should use caution when operating around the dock door. The LED light strip 870 can be further configured to display a red light as a signal that personnel should not use the corresponding dock door at that particular time. In the illustrated embodiment, the channel 876a is located on an outwardly facing surface of the track guard 820, but the track guard 820 can also include a second channel 876b located on a side-facing surface of the track guard 820 in addition to, or in place of, the channel 876a. The second channel 876b can be used to hold a second light strip which can be illuminated in the same way (e.g. in the same colors) as the light strip 870, or can be used to illuminate different types of light and/or at different times. In some embodiments, a reflective element, such as a strip of reflective material, can be positioned in the channel 876a to provide reflective light that can guide and/or otherwise assist drivers (e.g., fork lift drivers) as they drive through the adjacent doorway. For example, in some embodiments the reflective strip can be reflective tape that includes tiny glass beads, prisms, and/or metals to create a highly reflective surface. Such reflective materials can include a cloth substrate or other substrate that, in some embodiments, can carry an adhesive to fasten the reflective material to the track guard 820. In other embodiments, the reflective element can include reflective paint or the like, or a reflective member such as a conventional reflector that has a transparent plastic outer surface over an array of angled micro-prisms or spherical beads. Accordingly, in various embodiments the track guards described herein can include virtually any type of element or feature that is visually contrasting to the track guard base material. In many embodiments such features will be light reflective, but in general such features can include anything that can provide a contrasting visual appearance. In some embodiments, one advantage of positioning the lighting element, reflective element, and/or other element or component in the (recessed) channel 876a, is that the element/component can be protected from damage if the track guard is struck (by, for example, a fork lift) during operations.

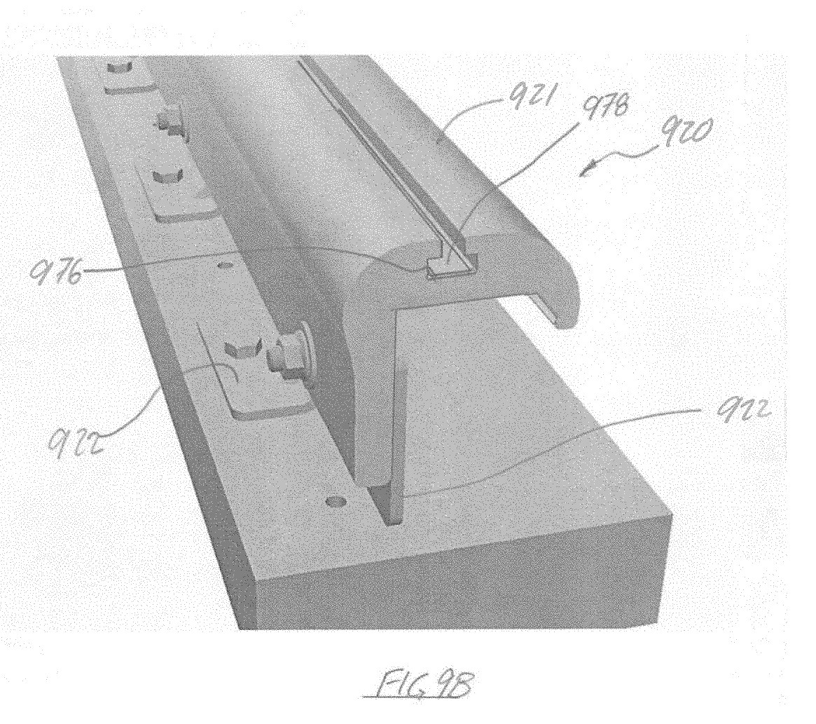

FIGS. 9A and 9B are isometric views of a track guard 920 configured in accordance with other embodiments of the present technology. In FIG. 9A, a lighting element (e.g., an LED light strip 970) is mounted to the track guard 920, and in FIG. 9B a reflective element (e.g., a reflector, reflective paint, and/or a reflective strip 978) is mounted to the track guard 920. FIG. 9C is a cross-sectional end view of the track guard 920 taken from FIG. 9A. Referring first to FIGS. 9A and 9C together, in the illustrated embodiment the track guard 920 includes an outer member 921 that is attached to a base member 922 which is in turn attached to the door jamb 234. In some embodiments, the outer member 921 can be formed from ultra-high molecular weight (UHMW) polyethylene that is extruded or otherwise formed using known methods, and the base member 922 can be formed from a suitable metal, such as a sheet metal, using known methods. In the illustrated embodiment, the outer member 921 can be fixedly attached to the base member 922 by a series of fasteners 940 (e.g., bolts and associated nuts) and the base member 922 can be securely attached to the door jamb 234 by means of suitable fasteners (e.g., screws) as described in detail above with reference to, for example, FIG. 6.

The track guard 920 can be used to protect an overhead door track 906 having a guide rail 930 that is attached to the door jamb 234 by means of an angle bracket 932. In the illustrated embodiment, the bracket 932 includes a flange that is sandwiched between the base member 922 and the door jamb 234. As shown in FIG. 9C, the guide rail 930 can be generally similar in structure and function to the guide rail 230 described above with reference to, for example, FIGS. 2 and 3, and can accordingly include a guide portion 931. In one aspect of the illustrated embodiment, however, the guide portion 931 is received in a recessed portion 950 of the outer member 921 that is defined by one or more flat, or at least generally flat, sidewall portions 951a, b. The recessed portion 950 further includes a lip or ridge 952 configured to contact or otherwise abut a longitudinal edge 954 of the guide portion 931.

In some embodiments the outer member 921 further includes a longitudinal groove or channel 976 having, e.g., an inverted ‘T’ cross-sectional shape. The LED light strip 970 can be positioned in the channel as shown in FIG. 9C so that the LED light elements project outwardly through the channel 976. The LED light strip 970 can be fixedly attached to the outer member 921 using one or more fasteners (e.g., screws), adhesive, etc. Additionally, as shown in FIG. 9A, the outer member 921 can include a through-hole or aperture 924 positioned near one or both ends of the outer member 921 to accommodate a power cord 972 that extends through the aperture 924. The power cord 972 can include an electrical connector 974 for coupling the LED light strip to a power source for operation as described above.

Returning to FIG. 9B, as noted above in this embodiment the reflective strip 978 is positioned in the longitudinal channel 976. In some embodiments, the reflective strip 978 can include or be formed from various types of reflective tapes and/or other reflective elements known in the art, such as reflective materials having micro-prisms, glass beads, and/or other reflective elements on their surface. Accordingly, essentially any type of reflective element, feature or material can be positioned in the channel 976 and/or elsewhere on the outer member 921 in accordance with the present technology. In use, the reflective material can assist vehicle operators (e.g., forklift drivers at loading docks, automobile drivers in residential applications, etc.) by warning them of the presence of the door track and/or helping to guide them through the adjacent doorway.

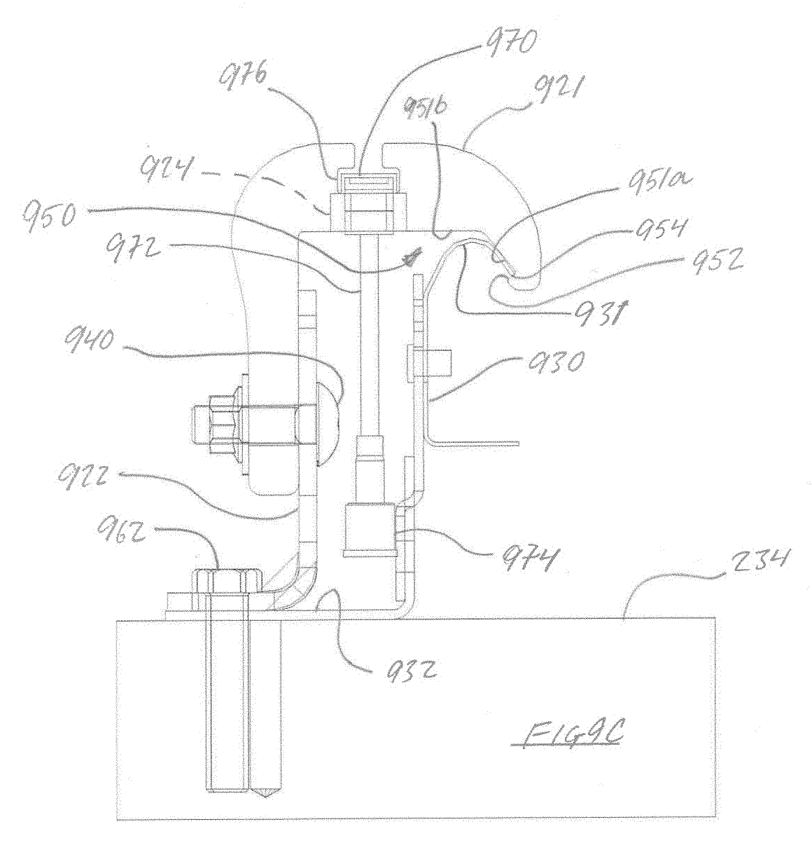

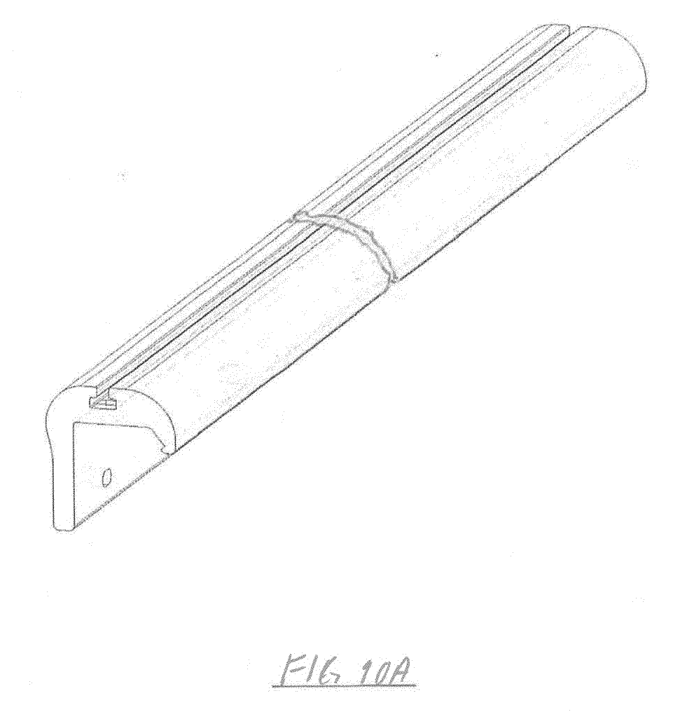

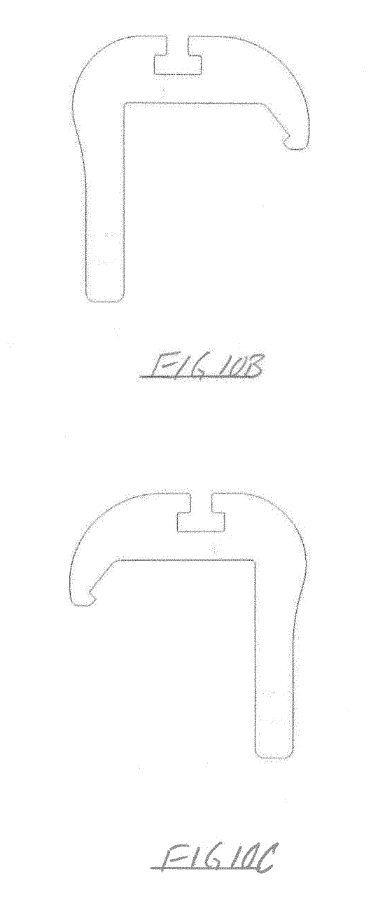

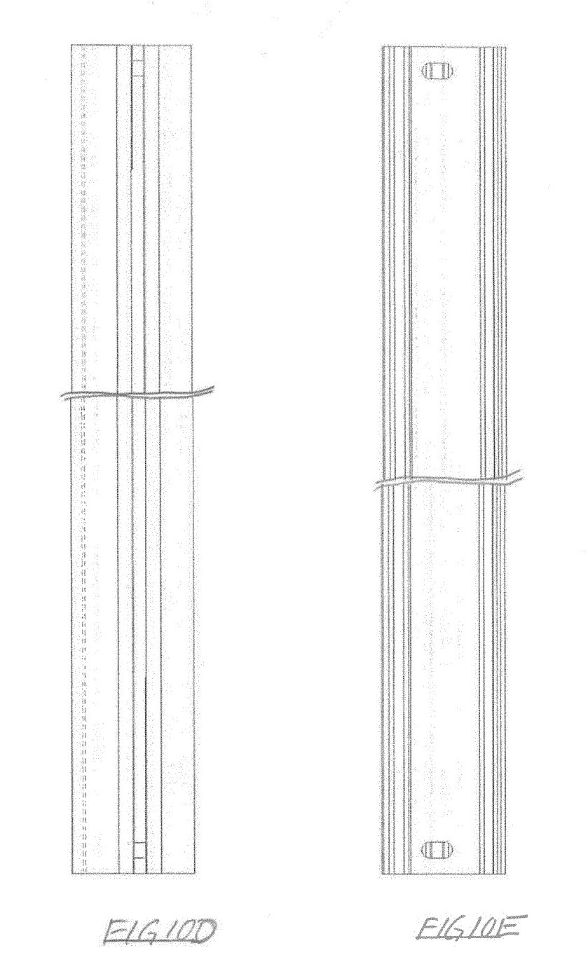

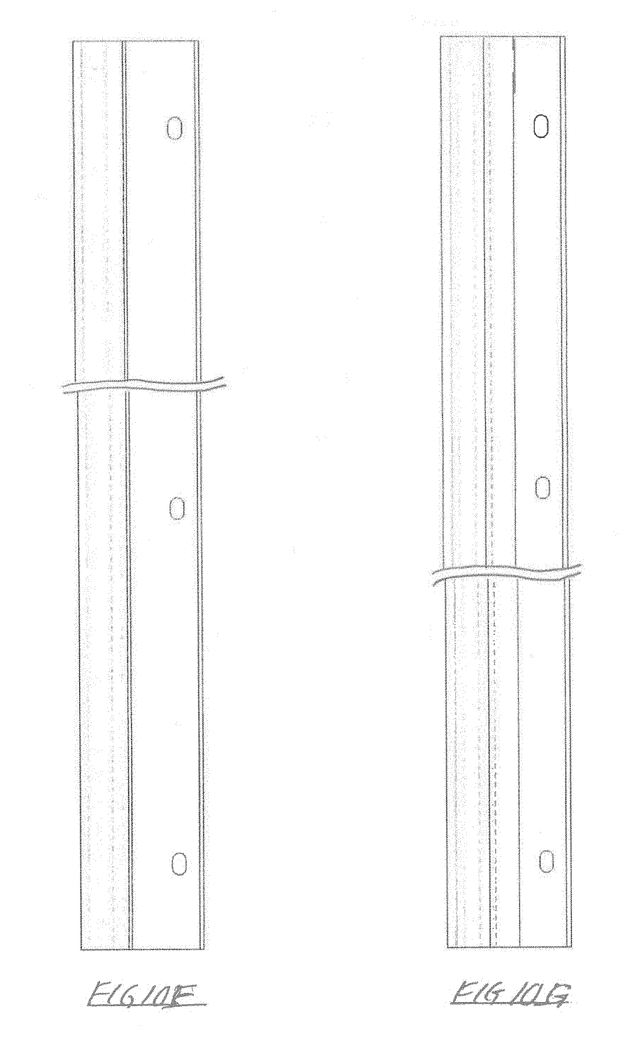

FIGS. 10A-10G are a series of views illustrating a design of a track guard member (e.g., the outer member 921 described above with reference to FIGS. 9A-9C). More specifically, FIG. 10A is a perspective view of the track guard member, FIG. 10B is a front view of the track guard member, FIG. 10C is a back view of the track guard member, FIG. 10D is a top view of the track guard member, FIG. 10E is a bottom view of the track guard member, FIG. 10F is a right-side view of the track guard member, and FIG. 10G is a left-side view of the track guard member. In some embodiments, the illustrated track guard member can be used with an overhead door track as described in detail above.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A track guard for use with an overhead door track mounted to a door jamb, the overhead door track having a guide rail configured to receive a guide member of an overhead door, the track guard comprising:
an outer member configured to be fixedly attached to the door jamb adjacent to the door track, wherein the outer member is configured to be positioned over at least a portion of the guide rail so that the guide rail is positioned at least partially between the outer member and the door jamb.

2. The track guard of claim 1 wherein the outer member is configured to protect the guide rail from impact damage.

3. The track guard of claim 1 wherein the outer member includes a recessed portion configured to receive the guide rail therein.

4. The track guard of claim 3 wherein the guide rail includes a curved guide portion configured to receive the door guide member therein, and wherein the recessed portion of the outer member is configured to receive the curved guide portion of the guide rail therein.

5. The track guard of claim 4 wherein the curved guide portion of the guide rail has a first cross-sectional shape, and wherein the recessed portion of the outer member has a second cross-sectional shape that is at least approximately the same as the first shape.

6. The track guard of claim 4 wherein the outer member further includes a longitudinal lip adjacent to the recessed portion, and wherein the longitudinal lip is configured to abut a longitudinal edge of the guide rail.

7. The track guard of claim 1, further comprising:
a base member configured to be fixedly attached to the door jamb adjacent the door track, wherein the outer member is configured to be attached to the base member, and whereby the position of the outer member relative to the guide rail can be adjusted before attachment of the outer member to the base member.

8. The track guard of claim 1 wherein the outer member includes a cap portion having a recessed portion configured to receive the guide rail therein, wherein the outer member further includes a first flange portion extending from the cap portion, and wherein the track guard further comprises:
a base member configured to be fixedly attached to the door jamb adjacent the door track, wherein the base member includes a second flange portion configured to be fixedly attached to the first flange portion.

9. The track guard of claim 8 wherein the first flange portion is configured to extend toward the door jamb, and wherein the second flange portion is configured to extend away from the door jamb.

10. The track guard of claim 8 wherein at least one of the first flange portion or the second flange portion includes a plurality of elongated fastener holes, wherein the first flange portion is configured to be attached to the second flange portion with a plurality of fasteners that extend through the elongated fastener holes, and wherein the elongated fastener holes enable the position of the outer member to be adjusted relative to the guide rail before attachment of the second flange portion to the first flange portion.

11. The track guard of claim 1 wherein the outer member includes a cap portion having a recessed portion configured to fit over at least one of a standard 2 inch profile guide rail or a standard 3 inch profile guide rail.

12. The track guard of claim 1 wherein the guide rail is configured to receive the guide member of the overhead door on a first side of the guide rail, and wherein the outer member is configured to be fixedly attached to the door jamb on a second side of the guide rail, opposite to the first side.

13. An overhead door assembly comprising:
an overhead door, the overhead door having a plurality of guide members extending from a side portion thereof;
a door track configured to be attached to a doorjamb, the door track including a guide rail configured to retain the guide members during movement of the overhead door relative to the door jamb; and
a track guard having a cap portion, wherein the track guard is configured to be attached to the door jamb adjacent to the door track so that the guide rail is positioned between the cap portion and the door jamb.

14. The overhead door assembly of claim 13 wherein the track guard is an elongate member configured to cover a substantial portion of the guide rail to protect the guide rail from impact damage.

15. The overhead door assembly of claim 13 wherein the guide rail includes a curved guide portion configured to movably retain the guide members therein, and wherein the cap portion includes a recessed portion configured to receive the curved guide portion of the guide rail therein.

16. The overhead door assembly of claim 13 wherein the guide rail includes a curved guide portion configured to movably retain the guide members therein, wherein the track guard is a one-piece member having the cap portion and a base portion, wherein the cap portion includes a recessed portion configured to receive the curved guide portion of the guide rail therein, and wherein the base portion is configured to be attached to the door jamb adjacent to the door track.

17. The overhead door assembly of claim 13, further comprising at least one of a lighting element or a reflective element, wherein the at least one of the lighting element or the reflective element is attached to an outwardly facing surface of the cap portion.

18. An apparatus for use with an overhead door track mounted to a door jamb, the overhead door track having a guide rail configured to receive a guide member of an overhead door, the apparatus comprising:
an outer member configured to be fixedly attached to the door jamb adjacent to the door track, wherein the outer member is configured to be positioned over at least a portion of the guide rail so that the portion of the guide rail is positioned at least partially between the outer member and the door jamb, wherein the outer member includes an attachment feature on an outwardly facing surface thereof, and wherein the attachment feature is configured to receive a mounting portion of an accessory to operably position the accessory proximate the overhead door.

19. The apparatus of claim 18 wherein the attachment feature includes a longitudinal groove in the outwardly facing surface of the outer member.

20. The apparatus of claim 18 wherein the attachment feature includes a longitudinal channel in the outwardly facing surface of the outer member, and wherein the apparatus further comprises an elongate lighting element operably positioned in the longitudinal channel.
